(19) United States
(12) Patent Application Publication
(10) Pub. No.: US 2024/0005202 A1
(43) Pub. Date: Jan. 4, 2024

(54) METHODS, SYSTEMS, AND MEDIA FOR ONE-ROUND FEDERATED LEARNING WITH PREDICTIVE SPACE BAYESIAN INFERENCE

(71) Applicants: Mohsin HASAN, North York (CA); Zehao ZHANG, Waterloo (CA); Pascal POUPART, Kitchener (CA); Guojun ZHANG, Montreal (CA); Xi CHEN, Brossard (CA)

(72) Inventors: Mohsin HASAN, North York (CA); Zehao ZHANG, Waterloo (CA); Pascal POUPART, Kitchener (CA); Guojun ZHANG, Montreal (CA); Xi CHEN, Brossard (CA)

(21) Appl. No.: 17/963,496

(22) Filed: Oct. 11, 2022

Related U.S. Application Data
(60) Provisional application No. 63/344,431, filed on May 20, 2022.

(51) Int. Cl. G06N 20/00; G06N 7/00

(52) U.S. Cl. CPC G06N 20/00; G06N 7/005

(57) ABSTRACT

Servers, methods and systems are disclosed for one-round Bayesian federated learning. Embodiments of the present disclosure may assume that each client produces samples from p(y|x, Di) (i.e. the local predictive posteriors), and combines this information to estimate p(y|x, D) (i.e. the global predictive posterior). In some embodiments, an ensemble method may be used that leverages principled Bayesian techniques to incorporate each client's uncertainty estimates.

### RELATED APPLICATIONS

The present application claims priority to U.S. provisional patent application No. 63/344,431 filed May 20, 2022, the entire contents of which are incorporated herein by reference.

### FIELD

The present disclosure relates to methods, systems, and media for training of model, in particular related to methods, systems, and media for one-round federated learning with predictive space Bayesian inference.

### BACKGROUND

Federated learning (FL) is a decentralized approach to train machine learning models at a server using distributed and heterogeneous training data sets from various client devices, without sharing raw data with a server. This machine learning approach has received considerable attention from the research community and industries because of the myriad of applications that require the privacy of user-generated data, such as activity on personal client devices. Federated learning performs distributed model training iteratively with two operations: 1) model optimization with local data sets, and 2) model aggregation (e.g. model averaging). In every round, the server sends a global model to a set of available clients. Each client optimizes the model with locally available data and then sends its updated model parameters (or updated local gradient) to the server via communication links. The server updates the global model by averaging the local models or gradients received from the mobile devices and shares it in the next iteration.

One approach to federated learning involves Bayesian inference. Generally, Bayesian inference provides a method of statistical inference in which Bayes' theorem is used to update the probability for a hypothesis as more evidence or information becomes available. In a machine learning context, Bayesian inference provides the benefit of potentially minimizing overfitting. Given such benefits, there is a continued need to efficiently implement Bayesian inference within a federated learning setting.

### SUMMARY

In various examples, the present disclosure describes methods, systems, and media for one-round federated learning with predictive space Bayesian inference. Embodiments of the present disclosure relate to performing Bayesian inference in a federated manner.

When observing a dataset, Bayesian inference can be used to compute a calibrated distribution over weights, called the posterior distribution, p(w|D). Furthermore, for some query point x, an uncertainty-aware prediction p(y|x, D) (termed the “predictive posterior at input x”) can be computed. This Bayesian framework is valuable due to its robust nature (e.g. it prevents overfitting). Therefore, there is an advantage in efficiently implementing the Bayesian framework in a federated setting, where the dataset is split as D=(D1, . . . , Dn), and each client obtains a portion of the dataset, with constraints on privacy.

Embodiments of the present disclosure may assume that each client produces samples from p(y|x, Di) (i.e. the local predictive posteriors), and combines this information to estimate p(y|x, D) (i.e. the global predictive posterior). In some embodiments, an ensemble method may be used that leverages principled Bayesian techniques to incorporate each client's uncertainty estimates. Accordingly, the ensemble method may perform better than standard techniques. Embodiments of the present disclosure attempt to aggregate the local posteriors, and thus, allow for potentially only one round of communication.

In contrast, many Bayesian and non-Bayesian FL methods are iterative and require multiple rounds of communication, thereby requiring more time and computational resources to perform training.

Furthermore, whereas some existing methods attempt to perform Bayesian federated learning in one or few rounds of communication, these existing methods exhibit various limitations. They typically require exact aggregation of model parameter values (i.e. weights), which is extremely difficult and resource-intensive in models having large parameter counts, such as deep learning models. These existing methods typically approximate the weight space posterior, which is likely to be inaccurate (due to high dimensionality), and/or lead to higher inaccuracies in predictions (since it is an intermediate computation). For example, a first existing approach, FedPA (described by Maruan Al-Shedivat, Jennifer Gillenwater, Eric Xing, and Afshin Rostamizadeh. “Federated learning via posterior averaging: A new perspective and practical algorithms”. In International Conference on Learning Representations, 2021), requires communicating large weight vectors in multiple rounds, and it approximates a weight space posterior as a Gaussian, which could be inaccurate. A second existing approach, Embarrassingly Parallel Markov Chain Monte Carlo (MCMC) (described by Willie Neiswanger, Chong Wang, and Eric Xing. “Asymptotically exact, embarrassingly parallel mcmc”, 2014, hereinafter “Neiswanger 2014”), requires communicating a large number of weight samples, and it approximates a weight space posterior as a Gaussian, which could be inaccurate, or by using a kernel density estimator, which has poor performance in high dimensions. A kernel density estimator is a specific method for estimating the functional form of a probability density given samples from it. The estimated density is the mixture of all the kernels centered at the given samples.

Embodiments of the present disclosure may overcome one or more of these limitations by performing a simplified Bayesian learning operation to approximate a prediction in prediction space (not weight space). Embodiments described herein may thereby solve the technical problems of:

REDUCED COMMUNICATION COSTS: One or few rounds of communication reduce the communication costs incurred during training.

REDUCED TIME AND COMPUTATIONAL RESOURCES: Fewer rounds of communication decrease the time and resources required for training. Models with high parameter counts can still be approximated using modest computing resources over a relatively short time due to the use of Bayesian approximation.

INCREASED ACCURACY OF PREDICTIONS: By operating in prediction space, Bayesian approximation is sufficient to generate accurate predictions.

As used herein, the term “machine learning” or “ML” may refer to a type of artificial intelligence that makes it possible for software programs to become more accurate at making predictions without explicitly programming them to do so.

As used herein, the term “model” may refer to a predictive model for performing an inference task (also called a prediction task), such as classification or generation of data. A model may be said to be implemented, embodied, run, or executed by an algorithm, computer program, or computational structure or device. In the present example embodiments, unless otherwise specified a model refers to a “machine learning model”, i.e., a predictive model implemented by an algorithm trained using deep learning or other machine learning techniques, such as a deep neural network (DNN).

As used herein, an “input sample” or “input data sample” may refer to any data sample used as an input to a machine learning model, such as image data. It may refer to a training data sample used to train a machine learning model, or to a data sample provided to a trained machine learning model which will infer (i.e. predict) an output based on the data sample for the task for which the machine learning model has been trained. Thus, for a machine learning model that performs a task of image classification, an input sample may be a single digital image.

As used herein, the terms “model output” or “output” may refer to an inference output of a model, such as a predicted classification distribution over a set of classes, data generated by a generative model, etc.

As used herein, the term “training” may refer to a procedure in which an algorithm uses historical data to extract patterns from them and learn to distinguish those patterns in as yet unseen data. Machine learning uses training to generate a trained model capable of performing a specific inference task. In many forms of machine learning, training data samples (i.e., input data samples used for training) are provided to the model, and an objective function or critic is applied to the model outputs, with the results being used to adjust the learnable parameters of the model. As used herein, the terms “objective function” and “loss function” both refer to an objective function used in training a model, an objective metric generated by an objective function may also be referred to interchangeably as a loss.

As used herein, the term “Bayesian inference” refers to a method in which Bayes' theorem is used to update the probability for a hypothesis as more information is available.

As used herein, the term “prior distribution” refers to a concept from Bayesian inference, namely the distribution of a parameter before any data is observed.

As used herein, the term “posterior distribution” refers to a concept from Bayesian inference, namely the distribution of the parameter after taking account the observed data.

As used herein, the term “sampling” refers to sampling from a probability distribution, i.e., a procedure to generate data points or numbers which obey the statistics of a specified probability distribution.

As used herein, the term “federated learning” refers to a framework for learning parameter values from data, in which the data is segmented into different subsets, each available to different compute nodes (called “clients”), with the restriction that data not be shared or leaked between the clients.

As used herein, a statement that an element is “for” a particular purpose may mean that the element performs a certain function or is configured to carry out one or more particular steps or operations, as described herein.

As used herein, statements that a second element is “based on” a first element may mean that characteristics of the second element are affected or determined at least in part by characteristics of the first element. The first element may be considered an input to an operation or calculation, or a series of operations or computations, which produces the second element as an output that is not independent from the first element.

In some aspects, the present disclosure describes a method for Bayesian federated learning. At each client computing system of a plurality of client computing systems, various steps are performed. A model space prior is obtained, comprising a prior probability distribution over a plurality of learnable parameters of a local model of the client computing system. A local dataset of the client computing system is processed to adjust one or more of the plurality of learnable parameters of the local model. The model space prior and the local model are processed to generate a local predictive posterior. The local predictive posteriors of the plurality of client computing systems are aggregated to generate a global predictive posterior.

In some examples, the local predictive posterior is generated using a Markov Chain Monte Carlo algorithm to process the model space prior and the local model.

In some examples, obtaining the model space prior comprises receiving the model space prior from a server that computes the model space prior.

In some examples, the model space prior is a predetermined model space prior, and obtaining the model space prior comprises retrieving the predetermined model space prior from a memory of the client computing system.

In some examples, aggregating the local predictive posteriors comprises: sending the local predictive posteriors of the plurality of client computing systems to a server to generate the global predictive posterior.

In some examples, aggregating the local predictive posteriors comprises receiving, at a first client computing system of the plurality of client computing systems, the local predictive posteriors of the plurality of client computing systems, and processing, at the first client computing system, the plurality of local predictive posteriors to generate the global predictive posterior.

In some examples, the local predictive posterior comprises a plurality of posterior probability samples over a corresponding plurality of query inputs.

In some examples, the plurality of query inputs used by each client computing system are obtained from a shared data set, and each client computing system obtains the shared data set from a server.

In some examples, aggregating the local predictive posteriors comprises using Gaussian approximation to, for each client computing system, process the respective local predictive posterior to estimate a respective sample mean and covariance, and process the sample means and covariances for the plurality of client computing systems to estimate a mean and covariance of the global predictive posterior.

In some examples, the global predictive posterior comprises a regression prediction, and processing the sample means and covariances comprises: averaging the sample means using a weight based on the covariances.

In some examples, aggregating the local predictive posteriors comprises using a Kernel Density Estimator to, for each client computing system, process a plurality of samples of the respective local predictive posterior to estimate a density of the respective local predictive posterior, and process the estimated densities for the plurality of client computing systems, using an optimization algorithm, to estimate the global predictive posterior.

In some examples, the method further comprises generating a trained global model based on the global predictive posterior.

In some examples, generating the trained global model comprises training the global model to approximate the global predictive posterior, on a server, using knowledge distillation, and the method further comprises communicating the trained global model to each client computing system of the plurality of client computing systems.

In some aspects, the present disclosure describes a non-transitory processor-readable medium having machine-executable instructions stored thereon which, when executed by a processing device of a computing system, cause the computing system to perform the steps of one or more of the methods described above.

In some aspects, the present disclosure describes a computing system comprising a processing device, and a memory storing thereon a local model comprising a plurality of learnable parameters, a local dataset, and machine-executable instructions. The instructions, when executed by the processing device, cause the computing system to perform Bayesian federated learning. A model space prior is obtained, comprising a prior probability distribution over the plurality of learnable parameters. The local dataset is processed to adjust one or more of the plurality of learnable parameters. The model space prior and the local model are processed to generate a local predictive posterior. A local predictive posterior of each client computing system of a plurality of client computing systems is obtained. The local predictive posteriors of the computing system and the plurality of client computing systems are aggregated to generate a global predictive posterior.

In some examples, aggregating the local predictive posteriors comprises using Gaussian approximation to, for the computing system and each client computing system, process the respective local predictive posterior to estimate a respective sample mean and covariance, and process the sample means and covariances for the plurality of client computing systems to estimate a mode of the global predictive posterior.

In some examples, aggregating the local predictive posteriors comprises using a Kernel Density Estimator to, for each client computing system, process a plurality of samples of the respective local predictive posterior to estimate a density of the respective local predictive posterior, and process the estimated densities for the plurality of client computing systems, using an optimization algorithm, to estimate the global predictive posterior.

In some aspects, the present disclosure describes a server comprising a processing device, and a memory storing thereon machine-executable instructions. The instructions, when executed by the processing device, cause the server to perform Bayesian federated learning by obtaining a local predictive posterior of each client computing system of a plurality of client computing systems, and aggregating the local predictive posteriors of the computing system and the plurality of client computing systems to generate a global predictive posterior.

In some examples, aggregating the local predictive posteriors comprises using Gaussian approximation to, for each client computing system, process the respective local predictive posterior to estimate a respective sample mean and covariance, and process the sample means and covariances for the plurality of client computing systems to estimate a mean and covariance of the global predictive posterior.

In some examples, aggregating the local predictive posteriors comprises using a Kernel Density Estimator to, for each client computing system, process a plurality of samples of the respective local predictive posterior to estimate a density of the respective local predictive posterior, and process the estimated densities for the plurality of client computing systems, using an optimization algorithm, to estimate the global predictive posterior.

### BRIEF DESCRIPTION OF THE DRAWINGS

Reference will now be made, by way of example, to the accompanying drawings which show example embodiments of the present application, and in which:

FIG. 1 is a block diagram of an example system that may be used to implement Bayesian federated learning;

FIG. 2A is a block diagram of an example server that may be used to implement examples described herein;

FIG. 2B is a block diagram of an example client computing system that may be used as part of examples described herein;

FIG. 3A is a block diagram of an example of a centralized Bayesian federated learning system according to an embodiment of the present disclosure;

FIG. 3B is a block diagram of an example of a decentralized Bayesian federated learning system according to another embodiment of the present disclosure;

FIG. 4 is a flowchart of a method for Bayesian federated learning according to a further embodiment of the present disclosure;

FIG. 5 is a flowchart of a method for Bayesian federated learning in a decentralized setting using Gaussian approximation, according to a further embodiment of the present disclosure;

FIG. 6 is a flowchart of a method for Bayesian federated learning in a centralized setting, according to a further embodiment of the present disclosure; and

FIG. 7 is a flowchart of a method for Bayesian federated learning using Kernel Density Estimator approximation, according to a further embodiment of the present disclosure.

Similar reference numerals may have been used in different figures to denote similar components.

### DESCRIPTION OF THE INVENTION

In examples disclosed herein, methods and systems are described that help to enable practical application of Bayesian federated learning (FL). The disclosed examples may help to address challenges that are unique to Bayesian FL and in particular to provide a one-round Bayesian FL system.

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure. Although these embodiments are described in sufficient detail to enable one skilled in the art to practice the disclosed embodiments, it is understood that these examples are not limiting, such that other embodiments may be used and changes may be made without departing from their spirit and scope. For example, the operations of methods shown and described herein are not necessarily performed in the order indicated and may be performed in parallel. It should also be understood that the methods may include more or fewer operations than are indicated. In some embodiments, operations described herein as separate operations may be combined. Conversely, what may be described herein as a single operation may be implemented in multiple operations.

Reference in the specification to “one embodiment” or “an embodiment” or “some embodiments,” means that a particular feature, structure, or characteristic described in conjunction with the embodiment can be included in at least one embodiment of the disclosure. The appearances of the phrase “embodiment” in various places in the specification do not necessarily all refer to the same embodiment.

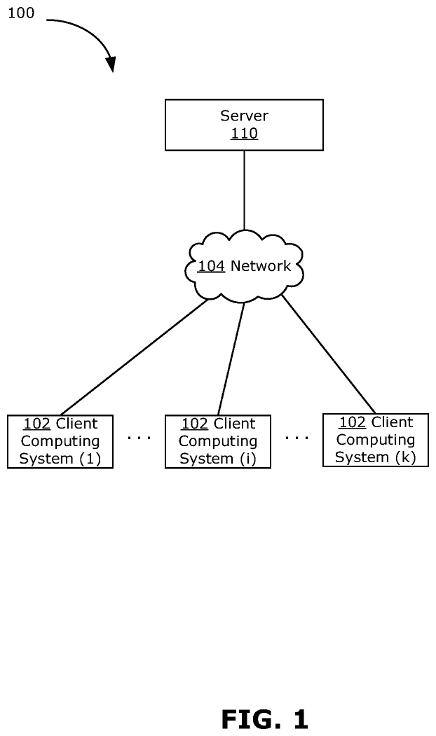

FIG. 1 illustrates an example system 100 that may be used to implement Bayesian FL according to examples described herein. The system 100 has been simplified in this example for ease of understanding; generally, there may be more entities and components in the system 100 than those shown in FIG. 1.

The system 100 includes a plurality of client computing systems 102 wherein each client computing system 102 is controlled by one of a plurality of different data owners. The client computing system 102 of each data owner collects and stores a respective set of private data (also referred to as a local dataset or private dataset). Each client computing system 102 can run a machine learning algorithm to learn values of learnable parameters of a local model using its respective set of local data (i.e., its local dataset). For the purposes of the present disclosure, running a machine learning algorithm at a client computing system 102 means executing computer-readable instructions of a machine learning algorithm to adjust the values of the learnable parameters of a local model. Examples of machine learning algorithms include supervised learning algorithms, unsupervised learning algorithms, and reinforcement learning algorithms. For generality, there may be N client computing system 102 (N being any integer larger than 1) and hence N sets of local data (also called local datasets). The local datasets are typically unique and distinct from each other, and it may not be possible to infer the characteristics or distribution of any one local dataset based on any other local dataset. A client computing system 102 may be a server, a collection of servers, an edge device, an end user device (which may include such devices (or may be referred to) as a client device/terminal, user equipment/device (UE), wireless transmit/receive unit (WTRU), mobile station, fixed or mobile subscriber unit, cellular telephone, station (STA), personal digital assistant (PDA), smartphone, laptop, computer, tablet, wireless sensor, wearable device, smart device, machine type communications device, smart (or connected) vehicles, or consumer electronics device, among other possibilities), or may be a network device (which may include (or may be referred to as) a base station (BS), router, access point (AP), personal basic service set (PBSS) coordinate point (PCP), eNodeB, or gNodeB, among other possibilities). In the case wherein a client computing system 102 is an end user device, the local dataset at the client computing system 102 may include local data that is collected or generated in the course of real-life use by user(s) of the client computing system 102 (e.g., captured images/videos, captured sensor data, captured tracking data, etc.). In the case wherein a client computing system 102 is a network device, the local data included in the local dataset at the client computing system 102 may be data that is collected from end user devices that are associated with or served by the network device. For example, a client computing system 102 that is a BS may collect data from a plurality of user devices (e.g., tracking data, network usage data, traffic data, etc.) and this may be stored as local data in the local dataset on the BS.

The client computing systems 102 communicate with a server 110 via a network 104. The network 104 may be any form of network (e.g., an intranet, the Internet, a P2P network, a WAN and/or a LAN) and may be a public network. Different client computing systems 102 may use different networks to communicate with the server 110, although only a single network 104 is illustrated for simplicity.

The server 110 may be used to coordinate communication among the client computing systems 102 in performing FL. The term “server”, as used herein, is not intended to be limited to a single hardware device: the server 110 may include a server device, a distributed computing system, a virtual machine running on an infrastructure of a datacenter, or infrastructure (e.g., virtual machines) provided as a service by a cloud service provider, among other possibilities. Generally, the server 110 (including the federated learning module 125 discussed further below) may be implemented using any suitable combination of hardware and software, and may be embodied as a single physical apparatus (e.g., a server device) or as a plurality of physical apparatuses (e.g., multiple machines sharing pooled resources such as in the case of a cloud service provider). The server 110 may implement techniques and methods to aggregate or otherwise coordinate predictions or other information of the client computing systems 102 during FL as described herein. In some examples, the server 110 and one or more of the client computing systems 102 may be implemented on a single platform or device under the control of a single user. In some examples, the operations described as being performed by the server may instead be performed in a distributed fashion by the client computing systems 102; for example, aggregation of predictions may in some example be performed by each client computing system 102 independently, or by one of the client computing systems 102 before being communicated to each other client computing system 102, in some embodiments.

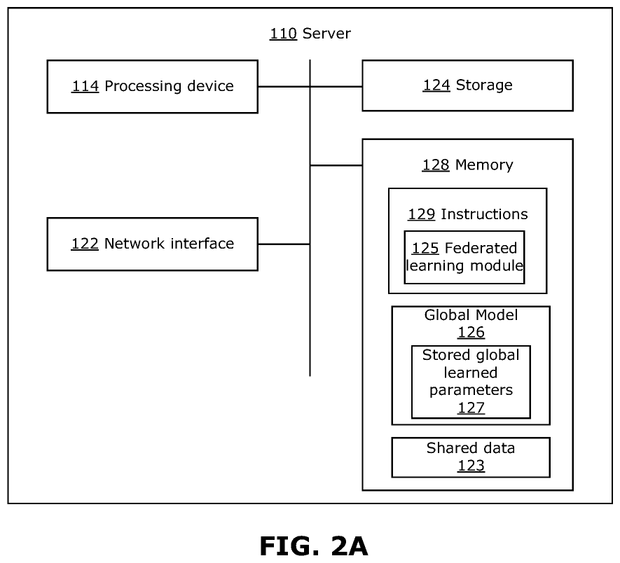

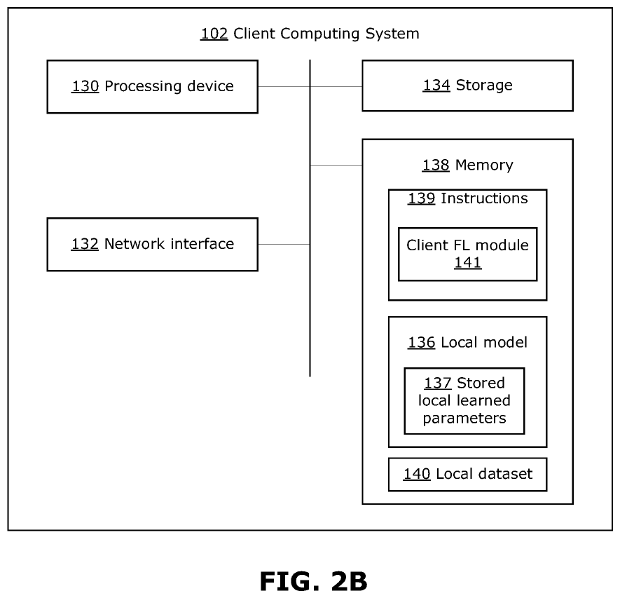

FIG. 2A is a block diagram illustrating a simplified example implementation of the server 110. Other examples suitable for implementing embodiments described in the present disclosure may be used, which may include components different from those discussed below. Although FIG. 2A shows a single instance of each component, there may be multiple instances of each component in the server 110.

The server 110 may include one or more processing devices 114, such as a processor, a microprocessor, a digital signal processor, an application-specific integrated circuit (ASIC), a field-programmable gate array (FPGA), a dedicated logic circuitry, a dedicated artificial intelligence processor unit, a tensor processing unit, a neural processing unit, a hardware accelerator, or combinations thereof. The one or more processing devices 114 may be jointly referred to herein as a processor 114, processor device 114, or processing device 114.

The server 110 may include one or more network interfaces 122 for wired or wireless communication with the network 104, the client computing systems 102, or other entity in the system 100. The network interface(s) 122 may include wired links (e.g., Ethernet cable) and/or wireless links (e.g., one or more antennas) for intra-network and/or inter-network communications.

The server 110 may also include one or more storage units 124, which may include a mass storage unit such as a solid state drive, a hard disk drive, a magnetic disk drive and/or an optical disk drive.

The server 110 may include one or more memories 128, which may include a volatile or non-volatile memory (e.g., a flash memory, a random access memory (RAM), and/or a read-only memory (ROM)). The one or more non-transitory memories 128 may be jointly referred to herein as a memory 128 for simplicity. The memory 128 may store processor executable instructions 129 for execution by the processing device(s) 114, such as to carry out examples described in the present disclosure. The memory 128 may include other software stored as processor executable instructions 129, such as for implementing an operating system and other applications/functions. In some examples, the memory 128 may include processor executable instructions 129 for execution by the processor 114 to implement a federated learning module 125 (for performing FL), as discussed further below. In some examples, the server 110 may additionally or alternatively execute instructions from an external memory (e.g., an external drive in wired or wireless communication with the server) or may be provided processor executable instructions by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

In some examples, the memory 128 may also store a shared dataset 123 consisting of shared data that can be used as training data. In some examples described herein, federated learning is performed by training all local models using the shared dataset 123. In some examples described herein, the shared dataset 123 is suitable for use as training data for each local model 136 described below, as well as optionally global model 126. For example, in the context of a supervised federated learning approach, the shared dataset 123 may consist of data pairs (x,y) each consisting of an input data sample x associated with a ground truth semantic label y. In some examples, the shared dataset 123 may be compiled by the server based on data received from one or more client computing systems 102, for example by aggregating non-private data from the local dataset 140 of each client computing system 102, as described below.

In some examples, the memory 128 may also store a global model 126 trained to perform a task. The global model 126 includes a plurality of learnable parameters 127 (referred to as “global learnable parameters” 127), such as learned weights and biases of a neural network, whose values may be adjusted during a training process until the global model 126 converges on a set of global learned parameter 127 values representing an optimized solution to the task which the global model 126 is being trained to perform. In addition to the global learnable parameters 127, the global model 126 may also include other data, such as hyperparameters, which may be defined by an architect or designer of the global model 126 (or by an automatic process) prior to training, such as at the time the global model 126 is designed or initialized. In machine learning, hyperparameters are parameters of a model that are used to control the learning process; hyperparameters are defined in contrast to learnable parameters, such as weights and biases of a neural network, whose values are adjusted during training. In some examples, the global model 126 participating in the FL operations described herein has the same architecture and operational hyperparameters as the various local models 136 described below, and differs from the local models 136 only in the values of its global learnable parameters 127, i.e. the values of the global learnable parameters 127 stored in the memory 128 after local training are stored as the learned values of the global learnable parameters 127.

FIG. 2B is a block diagram illustrating a simplified example implementation of a client computing system 102. Other examples suitable for implementing embodiments described in the present disclosure may be used, which may include components different from those discussed below. Although FIG. 2B shows a single instance of each component, there may be multiple instances of each component in the client computing system 102.

The client computing system 102 may include one or more processing devices 130 (also referred to herein as processor 130), one or more network interfaces 132, one or more storage units 134, and one or more non-transitory memories 138 (also referred to herein as memory 138), which may each be implemented using any suitable technology such as those described in the context of the server 110 above.

The memory 138 may store processor executable instructions 139 for execution by the processor 130, such as to carry out examples described in the present disclosure. The memory 138 may include other software stored as processor executable instructions 139, such as for implementing an operating system and other applications/functions. In some examples, the memory 138 may include processor executable instructions 139 for execution by the processing device 130 to implement a client federated learning module 141 (for performing FL), as discussed further below.

The memory 138 may also store a local dataset 140 consisting of private data that can be used as training data. In some examples described herein, federated learning is performed without the need to share the local dataset 140 of any client computing system 102 with any other system, such as any other client computing system 102 of the server 110. In some examples described herein, the local dataset 140 is suitable for use as training data for the local model 136: for example, in the context of a supervised federated learning approach, the local dataset 140 may consist of data pairs (x,y) each consisting of an input data sample x associated with a ground truth semantic label y.

In some examples, the memory 138 also stores the same shared data 123 (not shown) stored at the server 110. Such examples may eliminate the need of a round of communication to share the shared data 123 between the server 110 and each client computing device 102 when performing federated learning.

The memory 138 may also store a local model 136 trained to perform a task. The local model 136 includes a plurality of learnable parameters 137 (referred to as “local learnable parameters” 137), such as learned weights and biases of a neural network, whose values may be adjusted during a local training process based on the local dataset 140 until the local model 136 converges on a set of local learned parameter values representing an optimized solution to the task which the local model 136 is being trained to perform. In addition to the local learnable parameters 137, the local model 136 may also include other data, such as hyperparameters, which may be defined by an architect or designer of the local model 136 (or by an automatic process) prior to training, such as at the time the local model 136 is designed or initialized. In machine learning, hyperparameters are parameters of a model that are used to control the learning process; hyperparameters are defined in contrast to learnable parameters, such as weights and biases of a neural network, whose values are adjusted during training. In some examples, each local model 136 participating in the FL operations described herein has the same architecture and operational hyperparameters as the other local models 136, and differs from the other local models 136 only in the values of its local learnable parameters 137, i.e. the values of the local learnable parameters stored in the memory 138 after local training are stored as the learned values of the local learnable parameters 137.

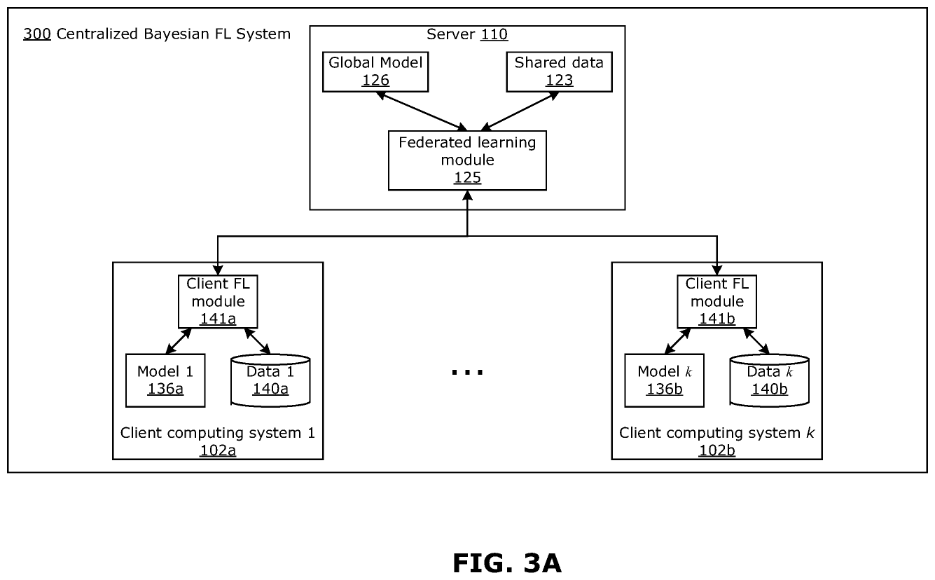

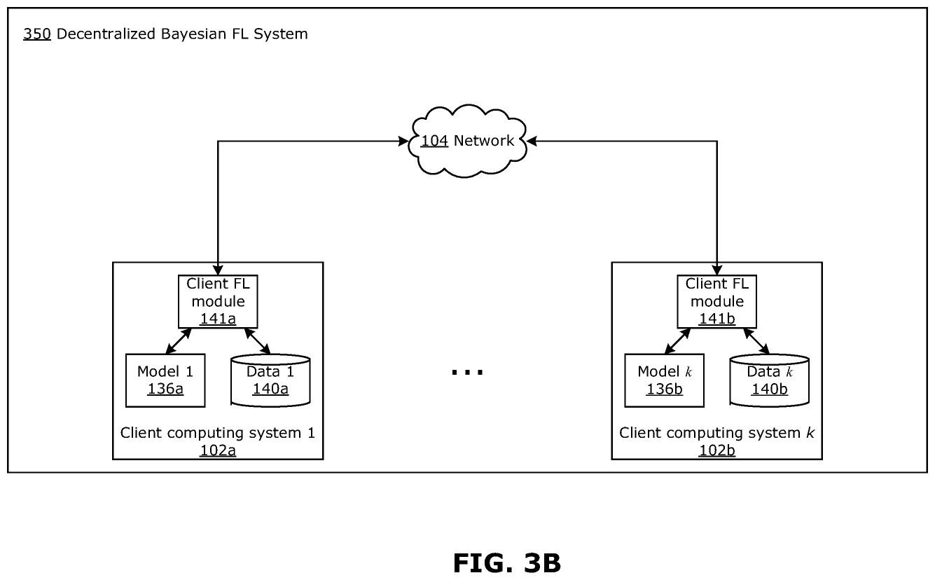

FIG. 3A shows a block diagram of an example centralized Bayesian federated learning system 300. Components in centralized Bayesian federated learning system 300 which are similar to the components in the system 100 are indicated using the same reference numeral. The centralized Bayesian federated learning system 300 includes client computing systems 102 of k data owners (shown as client computing system 1 102a through client computing system k 102b) and a server 110 which communicates with the client computing systems 102 of the k data owners. A given client computing system 102 may be referred to herein as a client computing system 102 or a specific client computing system 102i of client i (or data owner i).

Each client computing system 102 of a data owner stores a private local dataset 140 of the data owner (shown as 140a through 140b), a private local model 136 (shown as 136a through 136b), and a client FL module 141 (shown as 141a through 141b) that can fully access the private local dataset 140 and private local model 136 of the data owner. The client computing systems 102 of all k data owners use their private local datasets 140 and private local models 136 to collaborate in the centralized Bayesian federated learning system 300, and their goal is to achieve a trained model for a machine learning task T (hereinafter referred to as task T).

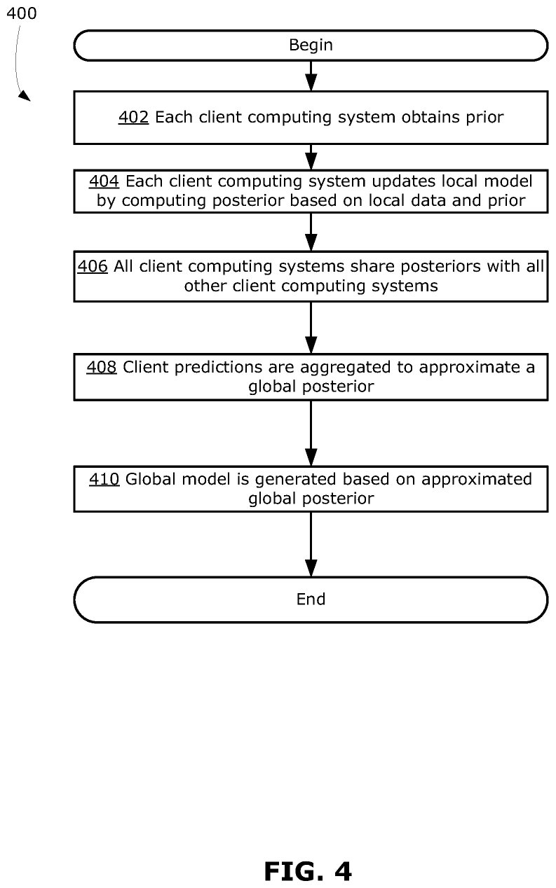

The centralized Bayesian federated learning system 300 also includes a server 110. The training of the local models 136 is coordinated using the server 110, which uses its federated learning module 125 to perform, in part, the methods described herein. The duty of the server 110 is to coordinate the training of the centralized Bayesian federated learning system 300 and provide some necessary information to the client computing systems 102 of the data owners. In some examples, the server 110 also uses the federated learning module 125 to generate values for the global learned parameters 127 of the global model 126, as described with reference to the methods of FIGS. 4-6.

Thus, the centralized Bayesian federated learning system 300 trains each local model 136 (and optionally global model 126) to perform a task T, using federated learning to draw on the data controlled by the other clients, coordinated using a server 110. None of the data owners or the server 110 has access to the local datasets 140 of the other data owners.

As shown in FIG. 3A, there are no connections or communications between the client computing systems 102 of the data owners. The communications are only between the client computing systems 102 of the data owners and the server 110.

FIG. 3B shows a block diagram of an example decentralized Bayesian federated learning system 350. Components in decentralized Bayesian federated learning system 350 which are similar to the components in the system 100 are indicated using the same reference numeral. The decentralized Bayesian federated learning system 350 includes client computing systems 102 of k data owners (shown as client computing system 1 102a through client computing system k 102b), but no server. Instead, each client computing system 102 communicates directly with each other client computing system 102 directly via the network 104.

As used herein, a “centralized” example, embodiment, system, method, setting, or context refers to an embodiment using a server to coordinate communications as in centralized Bayesian federated learning system 300, whereas a “decentralized” example, embodiment, system, method, setting, or context refers to an embodiment with no centralized server coordinating communications among the client computing systems 102 as in decentralized Bayesian federated learning system 350.

Training methods using Bayesian federated learning will now be described with reference to FIGS. 4-6. These methods may be performed, in some examples, by either a centralized Bayesian federated learning system 300 or a decentralized Bayesian federated learning system 350, as indicated at various described steps of the described methods.

As described, embodiments of the present disclosure may include a method to aggregate from client models (for local predictive posteriors p(y|x,Di)) trained by local data 140 into a global model approximating the global predictive posterior p(y|x,D). In some examples, such as embodiments operating in decentralized contexts (such as decentralized Bayesian federated learning system 350), each client computing system 102 aggregates the local predictive posteriors to generate the global model, which is used to replace or in addition to its local model 136. In some examples, such as embodiments operating in centralized contexts (such as centralized Bayesian federated learning system 300), the trained global model may be generated and optionally stored as a trained global model on the server 110, and may also be shared with each client computing system 102, such that each client computing system 102 stores the global model for use locally.

Accordingly, as further described herein, embodiments of the present disclosure may approximate Bayesian predictive posterior by computing the mode of p(y|x,D) from the individual client computing system 102 provided p(y|x,Di) samples. Each of the described methods generates a global Bayesian model based on a dataset composed of n shards: D=D1 u . . . u Dn, wherein each local dataset Di 140 is stored on an individual client computing system 102. In some examples, supervised learning is used such that each data point in the local datasets 140 is an input and output pair denoted as (x,y): i.e., an input data sample x and a corresponding semantic label y. The described methods may be effective to generate a model which can make predictions using the global predictive posterior distribution (also referred herein as the predictive posterior), denoted: p(y|x, D).

In the described examples, the set of learnable parameters (e.g. local learned parameters 137 or global learned parameters 127) of a model are denoted by w. Bayesian techniques allow for the training of a model which may provide robust uncertainty estimates. As noted above, the model is generated (i.e., trained) to make predictions using the predictive posterior distribution, denoted: p(y|x,D). Typically this training is performed by setting a “model space prior” p(w), and then obtaining approximate samples from the global model space posterior {w}={w1, . . . , wM}˜p(w|D)∝p(w)p(D|w). After obtaining these approximate samples are obtained from the global model space posterior {wj}˜p(w|D), the global model may be generated by estimating the integral:

$$\begin{matrix}p ( y \vert x , 𝒟 ) = \int p ( y \vert x , w ) p ( w \vert 𝒟 ) dw \\ \approx \frac{1}{M} {\sum }_{j} p ( y \vert x , {w}_{j} )\end{matrix} \qquad ( Equation 1 )$$

For a well chosen prior, this method can yield predictions with accurate uncertainty estimates.

In some examples, the global model space posterior may be approximated using the “local” model space posteriors p(w|Di), as described by (Neiswanger 2014) and (Maruan Al-Shedivat, Jennifer Gillenwater, Eric Xing, and Afshin Rostamizadeh. “Federated learning via posterior averaging: A new perspective and practical algorithms. In International Conference on Learning Representations, 2021, hereinafter “Al-Shedivat 2021”), both of which are hereby incorporated by reference in their entirety.

“Embarrassingly Parallel MCMC” (as described by Neiswanger 2014) performs Bayesian inference by drawing MCMC samples from a local so-called “subposterior” (the local model space posterior with a corrective factor from the prior of

$${( \frac{1}{p ( w )} )}^{\{ 1 - \frac{1}{M} \}} ,$$

assuming M clients), and then estimating the local densities either as Gaussians or with a kernel density estimator. These local subposteriors are then aggregated via multiplication to obtain an approximation for the global model space posterior. This global density is then sampled to obtain the desired posterior samples to which Equation 1 may be applied for inference.

“Federated Posterior Averaging” (as described by Al-Shedivat 2021) is similar to the above technique, except that it approximates the local posteriors as Gaussians specifically (i.e. not with a kernel density estimator), and uses an iterative algorithm for aggregating the local mean and covariance into the global mean (with cost scaling linearly with the number of model parameters). The method operates over multiple rounds of communication. The iterative algorithm works by decomposing the formula for the global covariance (obtained from the product of local posteriors approximated as Gaussians) into the inverse of a sum of rank-1 matrices. The inverse is then computed iteratively using the Sherman-Morrison formula, along with dynamic programming.

Thus, these approaches (described by Neiswanger 2014 and Al-Shedivat 2021) often try to approximate the model space posteriors (i.e. posteriors of the learned parameters of a model), for instance as Gaussians. The high-dimensional and multimodal nature of the model space posteriors means these approximations are typically of a poor quality, as described above. By contrast, in some examples the methods described herein directly aggregate the (low dimensional) local predictive posteriors p(y|x, Di) into an estimate for p(y|x, D).

Towards this end, the methods described herein assume that the data shards (i.e. local data sets 140) are independent, i.e. p(D)=Πᵢp(Dᵢ), and are conditionally independent given a datapoint (x,y): p(D|y, x)=Πᵢp(Dᵢ|y, x). It will be appreciated that each distribution need not be identical. Given these assumptions, the global predictive posterior decomposes as:

$$\begin{matrix}p ( y \vert x , 𝒟 ) = p ( y \vert x , {𝒟}_{1} , … , {𝒟}_{n} ) \\ = p ( {𝒟}_{1} , … , {𝒟}_{n} \vert y , x ) \frac{p ( y \vert x )}{p ( 𝒟 )} \\ = \frac{p ( y \vert x )}{p ( 𝒟 )} {\prod }_{i} p ( {𝒟}_{i} \vert y , x ) \\ = \frac{p ( y \vert x )}{p ( 𝒟 )} {\prod }_{i} p ( y \vert x , {𝒟}_{i} ) \frac{p ( {𝒟}_{i} )}{p ( y )} \\ = \frac{1}{{p ( y \vert x )}^{n - 1}} {\prod }_{i} p ( y \vert x , {𝒟}_{i} )\end{matrix} \qquad ( Equation 2 )$$

wherein p(y|x) is the “prior predictive distribution”, and is determined by the model space prior p(w) set for the model (e.g., global model 126 or a local model 136).

Assuming that each client computing system 102 is able to provide some approximation to its local predictive posterior p(y|x, Di), Equation (2) can be interpreted as an aggregation technique. Accordingly, examples described herein may make certain assumptions on the form of the predictions.

In some examples, an aggregation may be performed for a regression-based task. If the models are being trained to perform a regression-based inference task, the aggregation operations described herein may comprise aggregation for regression. For a regression task, y∈R^{d}. In this case, the local predictive posteriors can be approximated as (multivariate) Gaussians, i.e. normal distributions: p(y|x, Di)=N(μᵢ,Σᵢ). The prior predictive distribution can be similarly approximated as p(y|x)=N(μₚ, Σₚ).

Because the aggregation formula (2) multiplies or divides these densities, the global predictive posterior will also be a Gaussian with some mean μ_{g} and covariance Σ_{g}:

$${Σ}_{g} = {( {\sum }_{i} {Σ}_{i}^{- 1} - ( n - 1 ) {Σ}_{p}^{- 1} )}^{- 1} \qquad ( Equation 3 )$$

$${μ}_{g} = {Σ}_{g} ( {\sum }_{i} {Σ}_{i}^{- 1} {μ}_{i} - ( n - 1 ) {Σ}_{p}^{- 1} {μ}_{p} ) \qquad ( Equation 4 )$$

The required means and covariances in Equations 3 and 4 may be estimated given samples from each predictive distribution, which in turn may be obtained from samples from the model space posterior p(w|Di) using any MCMC method.

Briefly, MCMC methods are a class of algorithms for sampling from a probability distribution. By constructing a Markov chain that has the desired distribution as its equilibrium distribution, one can obtain samples of the desired distribution by recording states from the chain. The more steps that are included, the more closely the distribution of the sample matches the actual desired distribution. Various algorithms exist for constructing Markov chains and may be employed by various examples described herein, such as the Metropolis-Hastings algorithm.

It will be appreciated that the aggregation formulas described above have an intuitive interpretation. Assume a one-dimensional context, wherein Σᵢ=σᵢ² is the variance of the output from client i, i.e. client computing system 102i. A prior is selected with high uncertainty Σₚ=σₚ², and mean μₚ=0 (which are reasonable settings for an uninformative prior), such that these terms can be ignored in the equations above. The aggregation formulas in Equations 3 and 4 thus become the weighted sum:

$${μ}_{g} = {\sum }_{i} {r}_{i} {μ}_{i} \qquad ( Equation 5 )$$

$${r}_{i} = \frac{{( {σ}^{2} )}_{i}^{- 1}}{{\sum }_{i} {( {σ}^{2} )}_{i}^{- 1}}$$

wherein the weight rᵢ characterizes the uncertainty client i (i.e. client computing system 102i) has in its prediction at input x. A client with high uncertainty would have a correspondingly low weight, meaning it wouldn't influence the overall (mean) prediction very much. This is a helpful feature in contexts having heterogeneous data in the various local datasets 140. In these settings, a given local dataset Di 140 may not contain any data resembling, or close to, some query input x, and accordingly the training methods described herein may be configured such that the global prediction at x is not greatly influenced by clients having such local datasets Di 140.

In some examples described herein, the use of a Gaussian approximation is a reasonable approximation technique for generating predictive posteriors. Generally speaking, approximating a distribution by a Gaussian is reasonable when the distribution is unimodal and one assumes a loss based on the squared distance to a unique target value. As described above, the predictive posterior p(y|x,Di) is a distribution over output values y. In supervised regression, it can be assumed that there is a single target value y* and a training algorithm may seek to minimize the squared error (y−y*)². Similarly, under suitable conditions, Bayesian consistency (as described by Nogales, A. G. 2022. “On Consistency of the Bayes Estimator of the Density”. Mathematics, 10(4): 636, hereinafter “Nogales 2022”, which is hereby incorporated by reference in its entirety) ensures that the expectation of the predictive posterior will converge to the target value y* in probability (i.e., E_{p(y|x,D}_{ᵢ}₎[y]→y*). In the case of a Gaussian predictive posterior, the probability that a prediction y is correct is proportional to the exponential of the squared distance to the expectation (i.e., p(y|x,Di)∝exp((y−E_{p(y|x,D}_{ᵢ}₎[y]²). Hence, the assumption of a Gaussian predictive posterior is in line with the assumption of a unique target y* and the minimum squared error in supervised regression. In contrast, assuming a Gaussian posterior p(w|Di) in the model space would not be reasonable, because there are typically many equivalent models (due to symmetries) that can generate the same data Di. For instance, if one considers the space of neural networks with fully connected layers, it is well known that hidden nodes can be interchanged to obtain symmetrically equivalent models (as described by Pourzanjani, A. A.; Jiang, R. M.; and Petzold, L. R. 2017. “Improving the identifiability of neural networks for Bayesian inference”. In NeurIPS Workshop on Bayesian Deep Learning, which is hereby incorporated by reference in its entirety). Hence the model posterior p(w|Di) is typically multimodal and far from Gaussian.

In some examples, an aggregation may be performed for a classification-based task. If the models are being trained to perform a classification-based inference task, the aggregation operations described herein may comprise aggregation for classification. For a classification task, y is discrete. Assuming there are a manageable number of classes, the product in Equation 2 can be computed directly, i.e., for each value of y∈{l₁, . . . , lₖ} (wherein lᵢ is the ith class label):

$$p ( y = {l}_{j} \vert x , 𝒟 ) = \frac{1}{{p ( y = {l}_{j} \vert x )}^{n - 1}} {\prod }_{i} p ( y = {l}_{j} \vert x , {𝒟}_{i} ) \qquad ( Equation 6 )$$

Equation 6 can be interpreted in terms of uncertainties. First, Equation 6 is rewritten as:

$$p ( y \vert x , 𝒟 ) = p ( y \vert x ) {\prod }_{i} \frac{p ( y \vert x , {𝒟}_{i} )}{p ( y \vert x )} \qquad ( Equation 7 )$$

Each client contributes a factor of

$$\frac{p ( y \vert x , {𝒟}_{i} )}{p ( y \vert x )}$$

(i.e., the quotient of the posterior and prior in predictive space). If client i doesn't learn much (i.e., the local model 136i of client computing system 102i has local learned parameters 137 that are not adjusted significantly), and has little data (i.e., local model 136i has high uncertainty), the local posterior of local model 136i will be closer to the prior. Thus the factor

$$\frac{p ( y \vert x , {D}_{i} )}{p ( y \vert x )} \approx 1$$

for each y. This means the factor of client computing system 102i doesn't contribute significantly to the overall prediction.

Example methods will now be described for implementing the computations described above in the context of a centralized or decentralized Bayesian federated learning system 300, 350. Each method described below implements a general algorithm (referred to herein as “predictive space Bayes”, or PredBayes) that includes some version of the following steps:

Step 1. A model space prior, p(w), is obtained by each client computing system 102. The model space prior may be shared among or to the client computing systems 102, or predetermined and kept the same between client computing systems 102.

Step 2. The client computing systems 102 obtain their respective local predictive posteriors, p(w|Di), using a method such as variational inference or MCMC. For example, MCMC sampling may be used in some embodiments to generate samples according to the local posteriors {wj}˜p(w|Di).

Step 3. The client computing systems 102 may share these approximate models (i.e., local predictive posteriors) in a decentralized or centralized setting. In embodiments within a decentralized setting, client computing systems 102 may share p(w|Di), corresponding to the set of MCMC samples from Step 2, with each other. In some embodiments within a centralized setting, client computing systems 102 may share p(w|Di) with a central server 110. In other embodiments within a centralized setting, client computing systems 102 may share p(y|x, Di) on points x, belonging to shared dataset 123, to the central server 110. In some examples, the local posterior p(y|x, Di) may be generated by processing the set of MCMC samples {wj} at prediction time to generate predictions according to p(y|x, wj), then averaging the probabilistic predictions.

Step 4. Aggregation is performed to approximate global predictive posterior p(y|x,D) based on various assumptions on the form of p(y|x,Di). In some examples, the method uses a Gaussian approximation to approximate p(y|x,Di). In other examples, the method uses a Kernel Density Estimator to approximate p(y|x,Di).

Because the aggregation is done at the predictive space level, in some examples the algorithm described above essentially builds an ensemble of models to predict according to the global posterior. If there are k client computing systems 102, each of which draws M samples from the local posterior, then the ensemble has O(Mk) models. This version of the PredBayes algorithm is well-suited for applications having a limited number of client computing systems 102, and wherein each client computing systems 102 has the computational capabilities to store and perform inference with the ensemble. Thus, the PredBayes algorithm is suited to a cross-silo setting, i.e. an embodiments in which each client computing system 102 is a computationally powerful platform or device. To scale to a larger number of client computing systems 102, or where the client computing systems 102 are more computationally restricted, an additional step may be performed wherein the ensemble is distilled at the server 110 to obtain a single global model 126 which approximates the ensemble output. To do this, in Step 2 (communication) described above, the client data samples would be sent to server 110 instead of to each client computing system 102.

Some embodiments train a single global model 126 using knowledge distillation. The ensemble of local models 136 are used to approximate p(y|x,D), and this ensemble is used as a teacher model to train a student model (i.e. global model 126) using knowledge distillation. The global model 126 is generated by, or communicated to, each client computing device 102. The knowledge distillation procedure passes an unlabeled dataset through the teacher model to obtain targets for the student model, and the student model is trained to minimize the difference between the predictions of the student model and the teacher model. The global model 126 is then communicated from the server 110 to the client computing systems 102. This variant may be referred to herein as “distilled predictive Bayes” or DPredBayes. It will be appreciated that, in embodiments using DPredBayes, the space and time complexity (corresponding to the computational resources required across the entire federated learning system) at inference time may be reduced due to the training of only a single global model 126 instead of the ensemble of all local models 136. The procedure for embodiments using DPredBayes, as distinct from the four steps of PredBayes described above, is summarized in Algorithm 1 below:

Algorithm 1: DPredBayes

| Input: Client datasets [symbol] ᵢ, sampler MCMC_sample | |
|---|---|
| Output: Model w* | |
| for each client i do | |
| {w}ᵢ = MCMC_sample( [symbol] ᵢ) | {//step 1} |
| Communicate {w}ᵢ to server | {//step 2} |
| end for | |
| At Server: | |
| $\hat{p} ( y \vert x , {𝒟}_{i} ) = \frac{1}{\vert {\{ w \}}_{i} \vert} {\sum }_{w ∈ {\{ w \}}_{i}} p ( y \vert x , w )$ | {//step 3} |
| \hat{p}(y\|x, [symbol] ) = Aggregate(\hat{p}(y\|x, [symbol] ᵢ )) {//step 4, eq 5 & 7} | |
| w* = Distill(\hat{p}(y\|x, [symbol] )) | {//step 5} |
| return w* | |

It will be appreciated that the PredBayes algorithm (including the DPredBayes variant) is effective despite using only a single round of communication. This is because the sampling from the local posteriors can be done individually by each client computing system 102, and the aggregation operating (Step 4) computes p(y|x, D) in one step. This feature of the algorithm may alleviate many common problems faced by other FL techniques, such as synchronization issues, and the heavy cost of communication that multiple rounds bring with them.

FIG. 4 shows a first example method 400 for training a model using one-round of Bayesian federated learning.

At 402, a prior, p(w), is computed or otherwise obtained by each client computing system 102. In some examples, the local models 136 are initialized to a shared state, such that the prior computed by each client computing system 102 is identical to the other computed priors. In some examples, a single computed prior is shared by one of the client computing systems 102 with all of the other client computing systems 102. In some centralized examples, a server 110 shares a single computed prior with all of the client computing systems 102. Operation 402 implements a version of Step 1 of the PredBayes algorithm described above.

At 404, each client computing system 102 trains its respective local model 136 (i.e., adjust the values of the stored local learned parameters 137) by using its respective local dataset 140 as training data to compute a posterior p(w|Di), based on the computed prior and the local model 136 of the client computing system 102, using a technique such as variational inference or MCMC. Operation 404 implements a version of Step 2 of the PredBayes algorithm described above.

Variational inference and MCMC are two methods for estimating posterior distributions. MCMC is described above. Variational inference is a method for estimating a complicated or desired distribution (such as a Bayesian posterior) by first constructing a tractable distribution (i.e. a “simpler” distribution, meaning one which can be sampled from efficiently and accurately, and which possibly has a completely known formula for its density) with some free parameters, and then tuning those parameters such that the tractable distribution approximates the desired one as closely as possible. The tractable distribution is then used as a stand in for the desired distribution for any calculations of interest (such as making predictions).

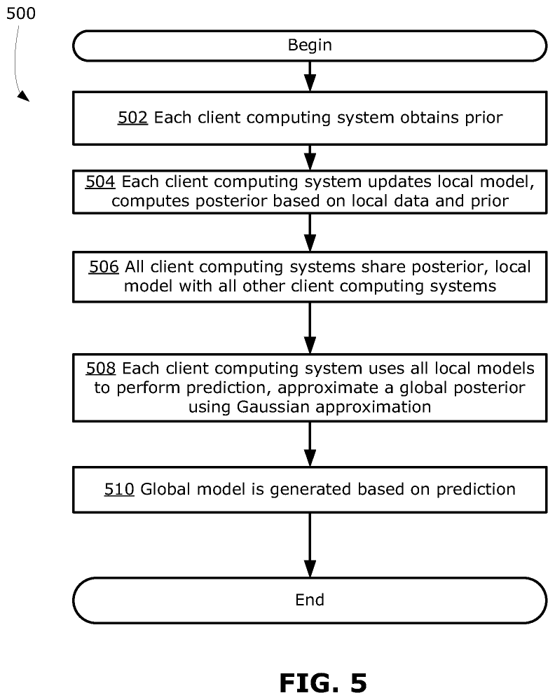

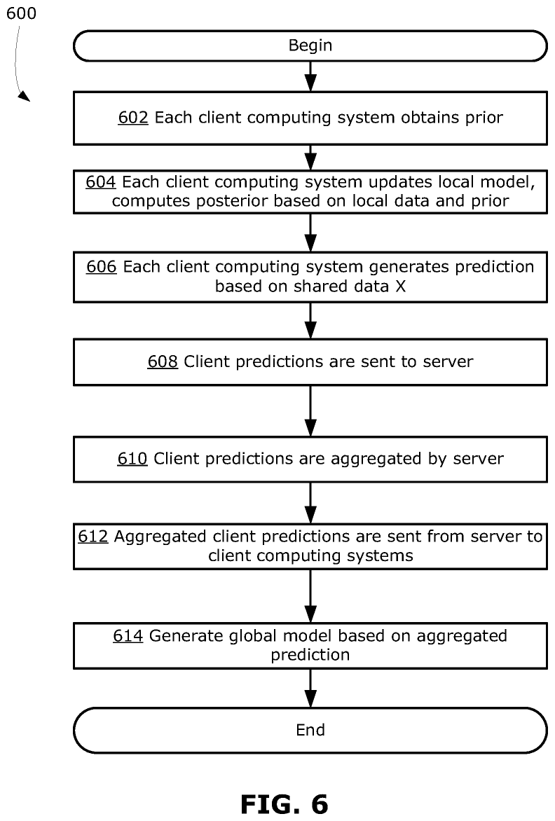

At 406, each client computing system 102 shares these approximate models in a decentralized setting (e.g., decentralized Bayesian federated learning system 350) or centralized setting (e.g., centralized Bayesian federated learning system 300). In embodiments operating within a decentralized setting, client computing systems 102 may share p(w|Di) with each other; one such example method 500 is described below with reference to FIG. 5. In some embodiments within a centralized setting, client computing systems 102 may share weight samples p(w|Di) with a central server 110. In other embodiments within a centralized setting, client computing systems 102 may share p(y|x, Di) on points x to the server 110, belonging to shared dataset 123; one such example method 600 is described below with reference to FIG. 6. In some such examples, the local posterior p(y|x, Di) may be generated by processing the set of MCMC samples {wj} at prediction time to generate predictions according to p(y|x, wj), then averaging the probabilistic predictions. Operation 406 implements a version of Step 3 of the PredBayes algorithm described above.

At 408, aggregation is performed to approximate p(y|x,D) based on certain assumptions on the form of p(y|x,Di). This approximation can be performed separately by each client computing system 102 in decentralized settings, or by the server 110 in centralized settings. Operation 408 implements a version of Step 4 of the PredBayes algorithm described above.

In some embodiments, operation 408 uses a Gaussian approximation at inference time to approximate the global predictive posterior at a point x, denoted p(y|x,D). First, samples are drawn from p(y|x,Di) at each client computing system 102 by using samples from p(w|Di) and performing inference with each sample on x. Second, the sample mean (μᵢ) and covariance (Σᵢ) are estimated for each client computing system 102. Third, these local means (μ₁ through μₖ) and variances (Σ₁ through Σₖ) are used to estimate the mean of p(y|x,D) in accordance with Equation 4. Because each local predictive posterior p(y|x,Di) is approximated to be Gaussian in this example, the global posterior p(y|x,D) will also be Gaussian, and is therefore fully specified by its mean and covariance.

In other embodiments, operation 408 uses a Kernel Density Estimator to approximate p(y|x,D). Each local posterior may be estimated as:

$$log p ( y \vert x , {D}_{i} ) \approx log ( \frac{1}{n h} {\sum }_{j} K ( \frac{y - {\hat{y}}_{\{ {D}_{i} , j \}}}{h} ) ) \qquad ( Equation 9 )$$

wherein K(d) is the “kernel function”, typically a Gaussian function: exp(−d²), and wherein ŷ_{{D}_{ᵢ}_{,j} denotes the jth sample of the local predictive posterior of client i (i.e. a sample of p(y|x,Di)).}

The aggregation formula is then computed as:

$${y}_{M A P} = {arg max}_{y} {\sum }_{i} log ( \frac{1}{{n}_{{D}_{i}} h} {\sum }_{j} K ( \frac{y - {\hat{y}}_{\{ {D}_{i} , j \}}}{h} ) ) - ( n - 1 ) log ( {\sum }_{j} \frac{1}{{n}_{p} h} K ( \frac{y - {\hat{y}}_{\{ p , j \}}}{h} ) ) \qquad ( Equation 10 )$$

wherein γ_{MAP} denotes the maximum a posteriori probability (MAP) of the global posterior, and the argument maximization is performed by an optimization algorithm such as gradient descent.

In some embodiments of method 400, such as some embodiments using a centralized setting, operation 410 may also be performed. At 410, each client computing system 102 tunes its local model 136 to match the aggregated predictions computed at operation 408. However, in some embodiments using a decentralized setting, the aggregated p(y|x,D) can be used “as-is” as an ensemble prediction, and operation 410 may be omitted. In some centralized embodiments using a server 110 having a global model 126, the stored global learned parameters 127 of the global model 126 may be adjusted to match the aggregated predictions computed at operation 408 and stored in the memory 128 of the server 110. In some embodiments, including decentralized embodiments, the stored local learned parameters 137 of one or more of the local models 136 may be adjusted to match the aggregated predictions computed at operation 408 and stored in the memory 138 of the respective client computing system 102.

Accordingly, method 400 may encompass various embodiments depending on at least two variables: first, whether the method 400 is implemented within a centralized setting (such as 300) or a decentralized setting (such as 350), and second, whether the approximation at operation 408 is computed as a Gaussian approximation or a Kernel Density Estimator approximation.

FIG. 5 shows a second example method 500 for training a model using one-round of Bayesian federated learning. Method 500 is a special case of method 400 in which a Gaussian aggregation approach is used in a decentralized setting such as decentralized Bayesian federated learning system 350.

At 502, each client computing system 102 obtains a prior p(w). In some examples, the prior p(w) is generated as a Gaussian, with 0 mean, and diagonal covariance. Operation 502 implements a version of Step 1 of the PredBayes algorithm described above.

At 504, the k client computing systems 102 train their respective local models 136 by applying a Bayesian inference algorithm, such as MCMC or variational inference, to their respective local datasets 140 and thereby each obtaining a model posterior p(w|Di). Operation 504 implements a version of Step 2 of the PredBayes algorithm described above.

At 506, each client computing system 102 communicates its local model 136 to each other client computing system 102. Because step 506 follows the training step 504, the local model 136 sent to the other client computing systems 102 reflects the adjusted values of the stored local learned parameters 137. Operation 506 implements a version of Step 3 of the PredBayes algorithm described above.

At 508, aggregation is performed by the client computing systems 102. In some embodiments, aggregation is performed at inference time using Gaussian aggregation, as described above at step 408 of method 400. Operation 508 implements a version of Step 4 of the PredBayes algorithm described above.

At 510, optionally, as at step 410 of method 400, a global model may be generated. Because a method 500 is performed in a decentralized setting, each client computing system 102 may either its local model 136 to match the aggregated predictions computed at operation 508 (thereby turning each local model 136 into a global model), or the aggregated p(y|x,D) can be used “as-is” as an ensemble prediction, and operation 510 may be omitted.

FIG. 6 shows a third example method 600 for training a model using one-round of Bayesian federated learning. Method 600 is a special case of method 400 in which either aggregation approach (Gaussian or Kernel Density Estimator) is used in a centralized setting such as centralized Bayesian federated learning system 300.

At 602, each client computing system 102 obtains a prior p(w). In some examples, the server 110 generates and sends to all client computing system 102 a single shared prior. In some examples, the prior p(w) is generated as a Gaussian, with 0 mean, and diagonal covariance. Operation 602 implements a version of Step 1 of the PredBayes algorithm described above.

At 604, the k client computing systems 102 train their respective local models 136 by applying a Bayesian inference algorithm, such as MCMC or variational inference, to their respective local datasets 140 and thereby each obtaining a model posterior p(w|Di). Operation 604 implements a version of Step 2 of the PredBayes algorithm described above.

At 606, information is shared using a shared dataset 123. In some examples, client computing systems 102 share p(y|x, Di) on points x, belonging to shared dataset 123, to the central server 110. The local posterior p(y|x, Di) may be generated by processing the set of MCMC samples {wj} at prediction time to generate predictions according to p(y|x, wj), then averaging the probabilistic predictions.

At 608, each client computing system 102 then communicates p(y|X,Di) (i.e., data samples, based on the shared dataset 123) to the server 110. Operations 606 and 608 implements a version of Step 3 of the PredBayes algorithm described above.

At 610, aggregation is performed by the server 110. In some embodiments, aggregation is performed at inference time using Gaussian aggregation to approximate p(y|x,D), as described above at step 408 of method 400. In some embodiments, aggregation is instead performed using a Kernel Density Estimator to approximate p(y|x,D), also as described above at step 408 of method 400. Operation 610 implements a version of Step 4 of the PredBayes algorithm described above.

At 612, optionally, the approximation of p(y|x,D) is then communicated by the server 110 to all client computing systems 102.

At 614, optionally, as at step 410 of method 400, a global model may be generated. Because a method 600 is performed in a decentralized setting, there are three possibilities: each client computing system 102 may either adjust its local model 136 to match the aggregated predictions computed at operation 608 (thereby turning each local model 136 into a global model); the aggregated p(y|x,D) can be used “as-is” as an ensemble prediction; and/or global model 126 may be trained (i.e. the global learned parameters 127 may be adjusted and stored) in accordance with the approximation of p(y|x,D).

In contrast to decentralized approaches such as method 500, centralized method like method 600 may lower the communication cost, because it only requires communication of samples from each client computing device 102 to the server 110 (i.e. k messages sent, one from each of k clients) instead of communication of the samples from each client computing device 102 to each other client computing device 102 (i.e., k² messages sent, from each of k clients to each other client).

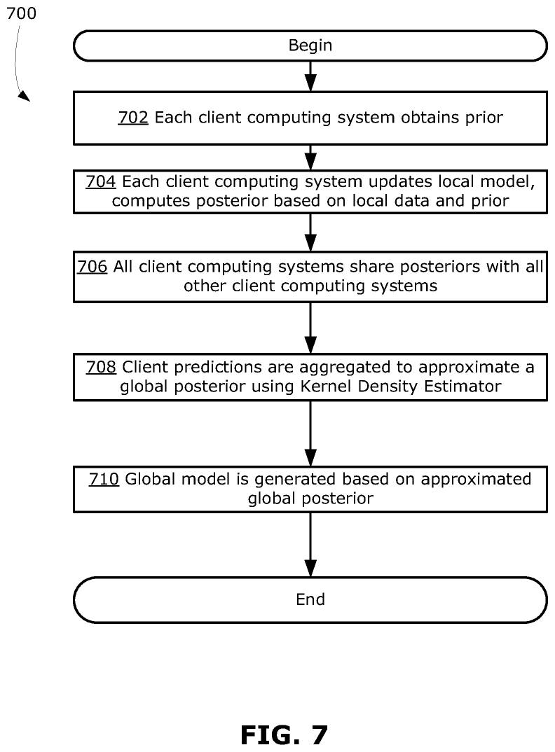

FIG. 7 shows a fourth example method 600 for training a model using one-round of Bayesian federated learning. Method 700 is a special case of method 400 in which a Kernel Density Estimator is used in a centralized or decentralized setting. Embodiments such as method 700 that use a Kernel Density Estimator may diverge from Gaussian approximation methods such as method 500 inasmuch as they use a different formula to determine the maximum a posteriori probability (MAP) of the global posterior.

At 702, as at step 402 of method 400, a prior, p(w), is obtained by each client computing system 102. Operation 702 implements a version of Step 1 of the PredBayes algorithm described above.

At 704, as at step 404 of method 400, each client computing system 102 trains its respective local model 136 and computes a posterior p(w|Di). Operation 704 implements a version of Step 2 of the PredBayes algorithm described above.

At 706, as at step 406 of method 400, each client computing system 102 shares the posterior p(w|Di) in a decentralized setting (e.g., decentralized Bayesian federated learning system 350) or centralized setting (e.g., centralized Bayesian federated learning system 300). Operation 706 implements a version of Step 3 of the PredBayes algorithm described above.

At 708, aggregation is performed to approximate p(y|x,D) based on certain assumptions on the form of p(y|x,Di). This approximation can be performed separately by each client computing system 102 in decentralized settings, or by the server 110 in centralized settings. Operation 708 uses a Kernel Density Estimator to approximate p(y|x,D), as described above at operation 408 of method 400.

At 710, optionally, a global model is generated, according to one or more of the techniques described above at step 410 of method 400.

It will be appreciated that methods 500, 600, and 700 are special cases of the general method 400 set out in FIG. 4. It will further be appreciated that, in some embodiments, the various alternative features of these methods 400, 500, 600, 700 may in some example be recombined: for example, some embodiments may operate in the decentralized setting of method 500 while using the Kernel Density Estimator approximation technique of method 700. Similarly, machine learning techniques described above such as knowledge distillation and/or supervised learning may be used in various suitable embodiments.

### Experimental Results

Various experiments have been performed to test the performance of example embodiments of the present disclosure. Tests were performed with and without knowledge distillation, to train models for both classification and regression-based inference tasks, using a variety of datasets for training and validation/testing. All tests were performed across a federated learning system comprising five client computing systems 102. For classification tasks, various degrees of data heterogeneity across the client computing systems 102 were tested. The local models 136 were implemented as either a two-layer fully connected network with 100 hidden units (for regression tasks and some classification tasks), or a convolutional neural network with 3 convolution layers, each followed by “Max Pooling” layers, with a single fully connected layer at the output end of the neural network (for the other classification tasks). All models used a ReLU activation function.

Performance of the federated learning systems was compared to baseline techniques including: Federated Averaging (FedAvg) (McMahan et al. 2017), Federated Posterior Averaging (FedPA) (Al-Shedivat et al. 2021), Embarrassingly Parallel MCMC (EP MCMC) (Neiswanger, Wang, and Xing 2014), One Shot Federated Learning (OneshotFL) (Guha, Talwalkar, and Smith 2019) (for classification, the ensemble is formed by averaging logits, before applying the softmax layer), and Federated Learning via Knowledge Transfer (FedKT) (Li, He, and Song 2021) (for classification only, using the ensemble/teacher for this method). FedAvg and FedPA are multi-round techniques; all others are one-round techniques. Each technique, including PredBayes and DPredBayes, was used to train the models using either 25 or epochs (depending on the training dataset) for classification tasks, or 20 epochs for regression tasks. Techniques using sampling (such as PredBayes) used a maximum of six samples.

The federated learning systems trained to perform classification tasks exhibited greatly improved accuracy over all other techniques, including multi-round techniques, as data heterogeneity increased from a purely homogeneous baseline. Even at low levels of data heterogeneity, PredBayes and DPredBayes exhibited better accuracy than all other one-round techniques as well as FedPA—the only technique that outperformed PredBayes and DPredBayes was the multi-round FedAvg technique, and its advantage was confined to extremely homogeneous distributions of the data across the client computing systems 102.

The federated learning systems trained to perform regression tasks exhibited greater accuracy than all other techniques for most datasets, and comparable (i.e. not a statistically significant difference) to the best-performing techniques in the remaining datasets.

Based on these experimental findings, it appears that the example embodiments described herein may be used to train models, using a single round of communication, to be more accurate at most classification and regression tasks than existing one-round and multi-round federated learning techniques.

### General

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method for Bayesian federated learning, comprising:
at each client computing system of a plurality of client computing systems:
obtaining a model space prior comprising a prior probability distribution over a plurality of learnable parameters of a local model of the client computing system;
processing a local dataset of the client computing system to adjust one or more of the plurality of learnable parameters of the local model; and
processing the model space prior and the local model to generate a local predictive posterior; and
aggregating the local predictive posteriors of the plurality of client computing systems to generate a global predictive posterior.

2. The method of claim 1, wherein:
the local predictive posterior is generated using a Markov Chain Monte Carlo algorithm to process the model space prior and the local model.

3. The method of claim 1, wherein:
obtaining the model space prior comprises receiving the model space prior from a server that computes the model space prior.

4. The method of claim 1, wherein:
the model space prior is a predetermined model space prior; and
obtaining the model space prior comprises retrieving the predetermined model space prior from a memory of the client computing system.

5. The method of claim 1, wherein:
aggregating the local predictive posteriors comprises:
sending the local predictive posteriors of the plurality of client computing systems to a server to generate the global predictive posterior.

6. The method of claim 1, wherein:
aggregating the local predictive posteriors comprises:
receiving, at a first client computing system of the plurality of client computing systems, the local predictive posteriors of the plurality of client computing systems; and
processing, at the first client computing system, the plurality of local predictive posteriors to generate the global predictive posterior.

7. The method of claim 1, wherein:
the local predictive posterior comprises a plurality of posterior probability samples over a corresponding plurality of query inputs.

8. The method of claim 7, wherein:
the plurality of query inputs used by each client computing system are obtained from a shared data set; and
each client computing system obtains the shared data set from a server.

9. The method of claim 1, wherein:
aggregating the local predictive posteriors comprises using Gaussian approximation to:
for each client computing system, process the respective local predictive posterior to estimate a respective sample mean and covariance; and
process the sample means and covariances for the plurality of client computing systems to estimate a mean and covariance of the global predictive posterior.

10. The method of claim 9, wherein:
the global predictive posterior comprises a regression prediction; and
processing the sample means and covariances comprises:
averaging the sample means using a weight based on the covariances.

11. The method of claim 1, wherein:
aggregating the local predictive posteriors comprises using a Kernel Density Estimator to:
for each client computing system, process a plurality of samples of the respective local predictive posterior to estimate a density of the respective local predictive posterior; and
process the estimated densities for the plurality of client computing systems, using an optimization algorithm, to estimate the global predictive posterior.

12. The method of claim 1, further comprising:
generating a trained global model based on the global predictive posterior.

13. The method of claim 12, wherein:
generating the trained global model comprises training the global model to approximate the global predictive posterior, on a server, using knowledge distillation; and
the method further comprises communicating the trained global model to each client computing system of the plurality of client computing systems.

14. A computing system comprising:
a processing device; and
a memory storing thereon:
a local model comprising a plurality of learnable parameters;
a local dataset; and
machine-executable instructions which, when executed by the processing device, cause the computing system to perform Bayesian federated learning by:
obtaining a model space prior comprising a prior probability distribution over the plurality of learnable parameters;
processing the local dataset to adjust one or more of the plurality of learnable parameters;
processing the model space prior and the local model to generate a local predictive posterior;
obtaining a local predictive posterior of each client computing system of a plurality of client computing systems; and
aggregating the local predictive posteriors of the computing system and the plurality of client computing systems to generate a global predictive posterior.

15. The computing system of claim 14, wherein:
aggregating the local predictive posteriors comprises using Gaussian approximation to:
for the computing system and each client computing system, process the respective local predictive posterior to estimate a respective sample mean and covariance; and
process the sample means and covariances for the plurality of client computing systems to estimate a mode of the global predictive posterior.

16. The computing system of claim 14, wherein:
aggregating the local predictive posteriors comprises using a Kernel Density Estimator to:
for each client computing system, process a plurality of samples of the respective local predictive posterior to estimate a density of the respective local predictive posterior; and
process the estimated densities for the plurality of client computing systems, using an optimization algorithm, to estimate the global predictive posterior.

17. A server comprising:
a processing device; and
a memory storing thereon machine-executable instructions which, when executed by the processing device, cause the server to perform Bayesian federated learning by:
obtaining a local predictive posterior of each client computing system of a plurality of client computing systems; and
aggregating the local predictive posteriors of the computing system and the plurality of client computing systems to generate a global predictive posterior.

18. The server of claim 17, wherein:
aggregating the local predictive posteriors comprises using Gaussian approximation to:
for each client computing system, process the respective local predictive posterior to estimate a respective sample mean and covariance; and
process the sample means and covariances for the plurality of client computing systems to estimate a mean and covariance of the global predictive posterior.

19. The server of claim 17, wherein:
aggregating the local predictive posteriors comprises using a Kernel Density Estimator to:
for each client computing system, process a plurality of samples of the respective local predictive posterior to estimate a density of the respective local predictive posterior; and
process the estimated densities for the plurality of client computing systems, using an optimization algorithm, to estimate the global predictive posterior.

20. A non-transitory processor-readable medium having machine-executable instructions stored thereon which, when executed by a processing device of a computing system, cause the computing system to perform the steps of the method of claim 1.
